(19) United States
(12) Patent Application Publication
(10) Pub. No.: US 2015/0304977 A1
(43) Pub. Date: Oct. 22, 2015

(54) METHOD AND APPARATUS FOR TIMING ADVANCE SELECTION FOR SYNCHRONIZED UPLINK TRANSMISSION

(71) Applicant: QUALCOMM INCORPORATED, San Diego, CA (US)

(72) Inventors: Gaoshan LI, Beijing (CN); Insung KANG, San Diego, CA (US)

(73) Assignee: QUALCOMM Incorporated, San Diego, CA (US)

(21) Appl. No.: 14/651,224

(22) PCT Filed: Oct. 24, 2013
(86) PCT No.: PCT/CN2013/085887

§ 371 Date: Jun. 10, 2015

(30) Foreign Application Priority Data
Dec. 10, 2012 (CN) PCT/CN2012/086277

(51) Int. Cl. H04W 56/00; H04W 52/02; H04W 74/08; H04B 7/26

(52) U.S. Cl. CPC H04W 56/0045; H04W 56/003; H04B 7/2656; H04W 52/0238; H04W 74/0833

(57) ABSTRACT

A user equipment (UE) may reducing the interference and improve the random access of the multiple users in the network. In some instances, the UE adjusts a timing advance and/or guard period values to reduce the interference experienced in a particular guard period. The adjustment is based on selecting a timing advance parameter for uplink synchronization based at least in part on an interference distribution in a guard period of a frame in a TD-SCDMA network.

### CLAIM OF PRIORITY UNDER 35 U.S.C §119

The present Application for Patent claims priority to PCT Application No. PCT/CN/2012/086277 entitled “TIMING ADVANCE SELECTION FOR SYNCHRONIZED UPLINK TRANSMISSION” filed Dec. 10, 2012, in the Receiving Office of China (RO/CN), and assigned to the assignee hereof and hereby expressly incorporated by reference herein.

### BACKGROUND

1. Field

Aspects of the present disclosure relate generally to wireless communication systems, and more particularly, to improving a selection of timing advance for uplink synchronization.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A user equipment (UE) may reducing the interference and improve the random access of the multiple users in the network. In some instances, the UE adjusts a timing advance and/or guard period values to reduce the interference experienced in a particular guard period. The adjustment is based on selecting a timing advance parameter for uplink synchronization based at least in part on an interference distribution in a guard period of a frame in a TD-SCDMA network.

A method for improving a selection of timing advance for uplink synchronization is provided. The method includes receiving an interference distribution information. Additionally, the method includes selecting a timing advance parameter for uplink synchronization based at least in part on the interference distribution information. Furthermore, the method includes communicating according to the selected timing advance parameter.

In another aspect, an apparatus for improving a selection of timing advance for uplink synchronization is provided. The apparatus includes a processor configured to receive an interference distribution information. Additionally, the processor is configured to select a timing advance parameter for uplink synchronization based at least in part on the interference distribution information. Furthermore, processor is configured to communicate according to the selected timing advance parameter.

In another aspect, an apparatus for improving a selection of timing advance for uplink synchronization is provided that includes means for receiving an interference distribution information. Additionally, the apparatus includes means for selecting a timing advance parameter for uplink synchronization based at least in part on the interference distribution information. Furthermore, the apparatus includes means for communicating according to the selected timing advance parameter.

In yet another aspect, a computer-readable media for improving a selection of timing advance for uplink synchronization is provided that includes machine-executable code for receiving an interference distribution information. Additionally, the code may be executable for selecting a timing advance parameter for uplink synchronization based at least in part on the interference distribution information. Furthermore, the code may be executable for communicating according to the selected timing advance parameter.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 shows exemplary TD-SCDMA sub frame structures illustrating a timing advance implementation for uplink synchronization.

FIG. 5 is a block diagram illustrating an example network deployment of user equipments and node Bs.

FIG. 6 is a block diagram showing uplink transmission of SYNC-UL carried by UPPCH as well as DwPTS transmitted at different times in a sequential order.

FIG. 7 is a block diagram showing an exemplary base timeline of node B and a subframe structure transmission timeline illustrating interference observed by the node B.

FIG. 8 is a block diagram showing an exemplary base timeline of node B and a subframe structure transmission timeline illustrating interference observed by NB 0.

FIG. 9 is a schematic diagram illustrating an example aspect of call processing in a wireless communication system;

FIG. 10 shows an exemplary base timeline of node B 0 and a subframe structure transmission timeline according to one aspect of the present disclosure.

FIG. 11 shows an exemplary base timeline of node B juxtaposed against a subframe structure transmission timeline.

FIG. 12 is a block diagram illustrating a timing advance selection method according to one aspect of the present disclosure.

FIG. 13 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

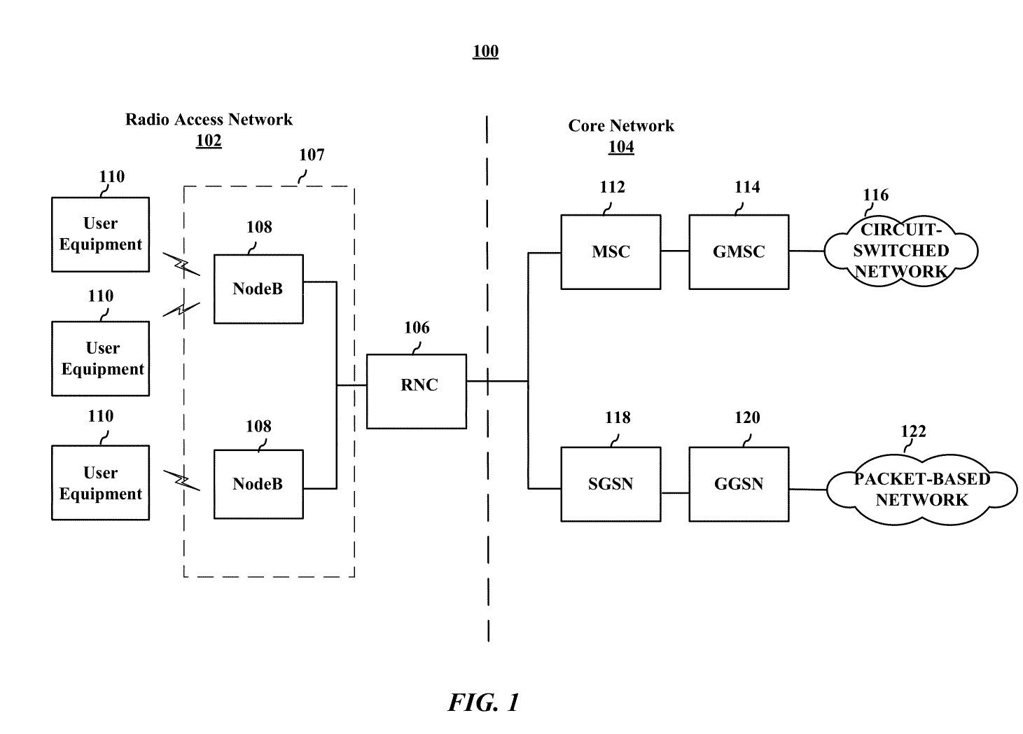

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

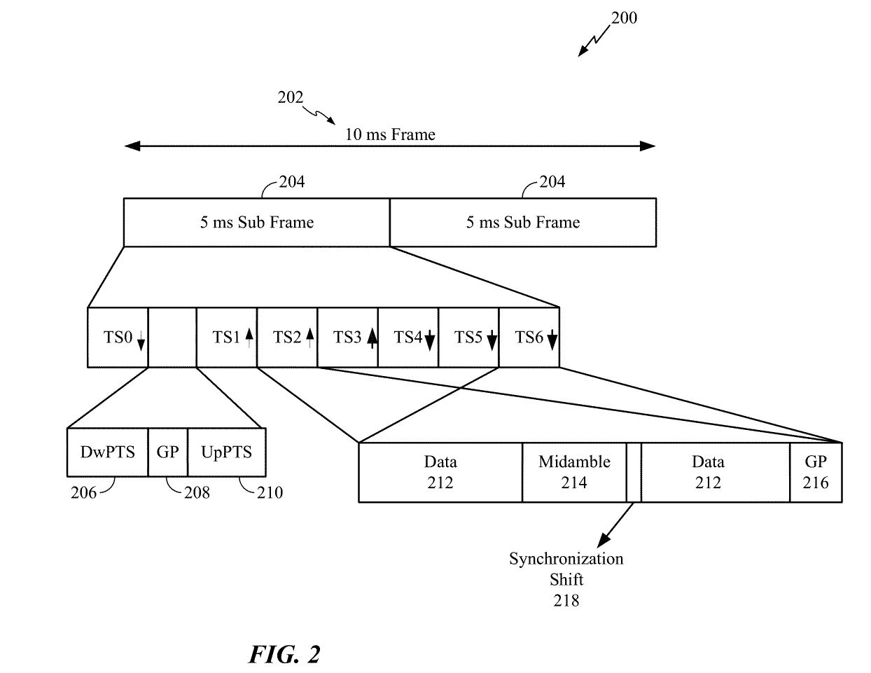

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

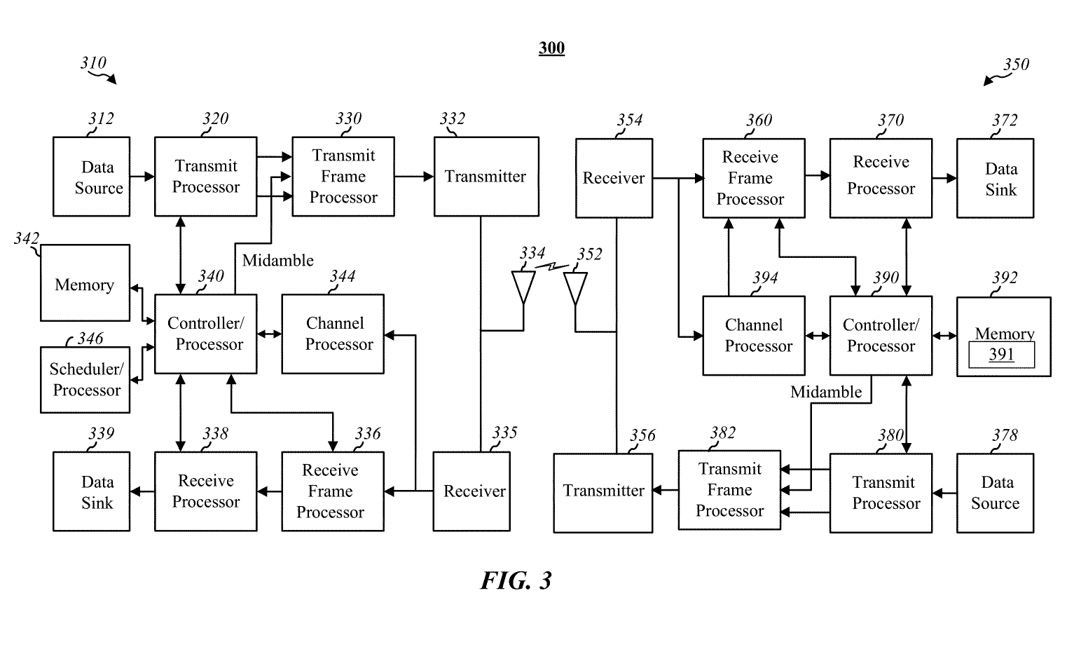

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a timing advance selection module 391 which, when executed by the controller/processor 390, configures the UE 350 for inter-RAT/inter-frequency measurements. A scheduler/processor 346 at the node B 310 may be used to allocate resources to the UEs and schedule downlink and/or uplink transmissions for the UEs.

### Timing Advance Selection for Synchronized Uplink Transmission

Some TD-SCDMA protocols provide methods to advance the uplink transmission timing. First, in a random access procedure, the UE sends synchronization uplink (SYNC_UL) codes on the Uplink Pilot Time Slot (UpPTS), and a node B measures and sends to the UE the timing information on the Fast Physical Access Channel (FPACH). The Fast Physical Access Channel message format may be configured such that the received starting position of the UpPCH parameter may be used to initially determine the timing advance value at the UE.

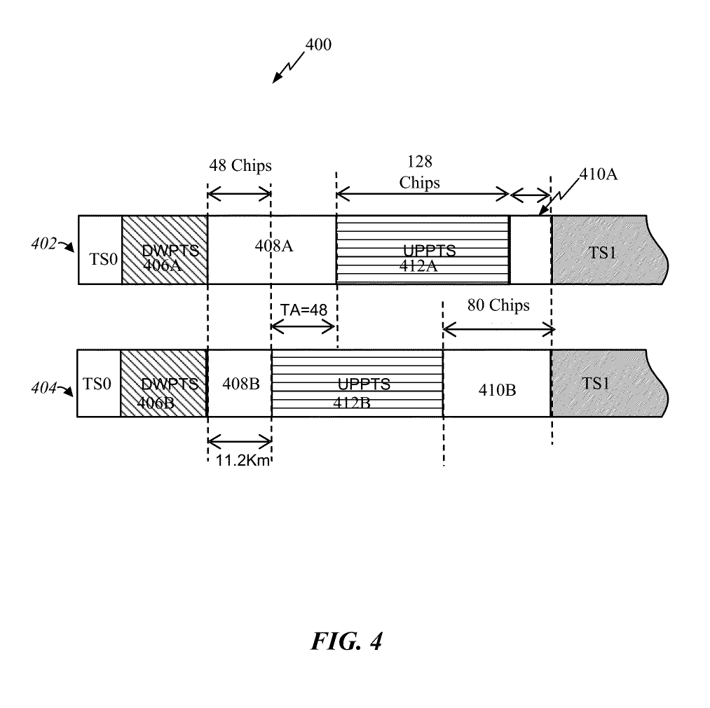

FIG. 4 is a block diagram 400 showing exemplary TD-SCDMA sub frame structures to illustrate a timing advance implementation for uplink synchronization. A first subframe structure 402 includes a first DwPTS 406A, a first guard period (GP) 408A, a second guard period (GP) 410A and a first UpPTS 412A (also known as the uplink pilot channel (UpPCH)) located between TS0 and TS1. A second subframe structure 404 includes a second DwPTS 406B, a third guard period 408B, a fourth guard period (GP) 410B, and a second UpPTS 412B located between TS0 and TS1. As noted, DwPTS is used for downlink synchronization and UpPTS is used for uplink synchronization.

The first UpPTS 412A contains a synchronization uplink sequence (SYNC-UL) of 128 chips and the second guard period 410A is 32 chips. The SYNC-UL in TD-SCDMA systems is used for identification in a random access procedure. The guard period is a switching point. For example, the guard periods 408A and 408B are the switching point from transmitting to receiving within the subframe structure 402 or 404. The duration of the first guard period 408A is 96 chips, from which a basic cell radius of 11.2 kilometers (km) may be derived. Each guard period 408A, 408B, 410A or 410B should be long enough to avoid uplink and downlink interference. For example, the transmission of the second UpPTS 412B can be advanced up to 48 chips from the second DwPTS 406B while maintaining a second guard period 408B of 48 chips that is long enough to reduce the uplink and downlink interference. The timeline associated with second guard period 408B may be deemed a base timeline of a node B. Control of uplink transmission to coordinate arrival time at the node B may be performed by the UE to properly advance its uplink transmission of a 10-ms long frame relative to the received downlink 10-ms frame time. This advance is called a timing advance (TA).

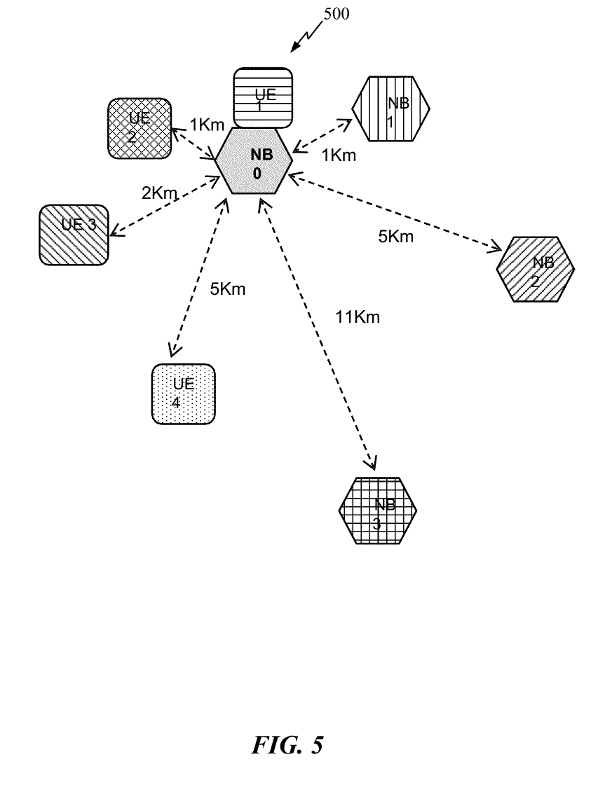

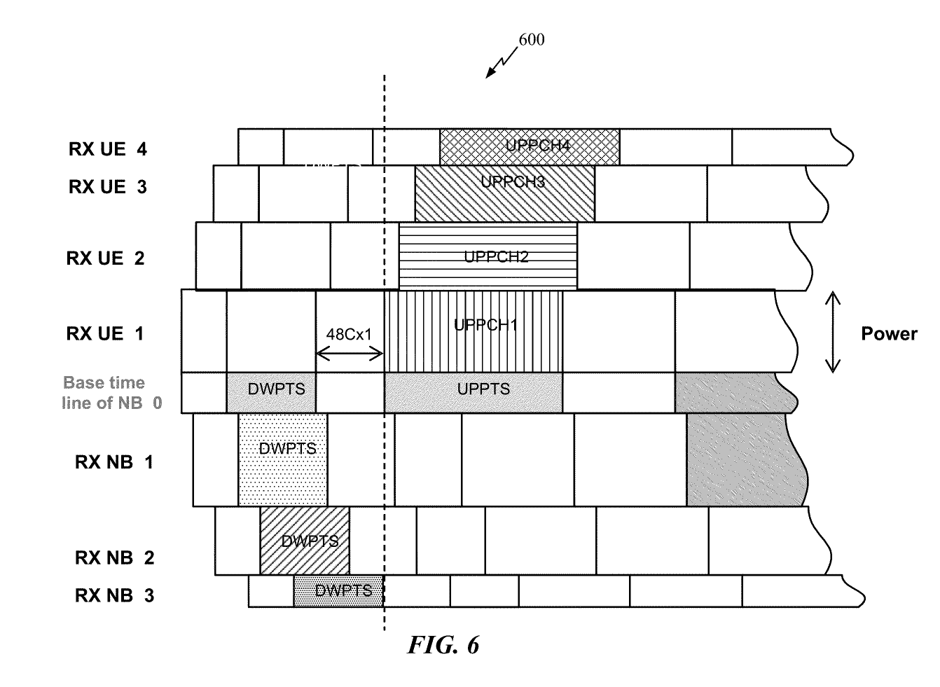

In TD-SCDMA, uplink and downlink transmission is synchronized at the node B. As shown in FIGS. 5 and 6, the uplink transmissions of user equipments UE 1, UE 2, UE 3, UE 4, and the downlink transmission of node B, NB 0, to node Bs NB 1, NB 2 and NB 3 can be coordinated.

FIG. 5 is a block diagram 500 illustrating an example network deployment of user equipments as well as node Bs disposed at different distances from a synchronization node B, NB 0. The arrival time of uplink transmissions, (e.g., SYNC-UL carried by UpPCH) at NB 0 from the UEs as well as the downlink transmission (e.g., DwPTS) from NB1, NB 2 and NB 3 may be based on the distance of the nodes as well as the user equipments from NB 0. For example, UE1 which is closest to NB 0 may transmit earlier than the UE 4 which is furthest (i.e., 11 kilometers (km)) from NB 0. Thus, the transmission of the SYNC-UL of UE 4 arrives at NB 0 later than the SYNC-UL of UE 1. Similarly, DwPTS from other node Bs may be received by NB 0 at different times in a sequential order. For example, DwPTS for NB 1, which is closest (1 km from NB 0) to NB 0 may be received by NB 0 at an earlier time than the DwPTS for NB 3, which is furthest (11 km from NB 0) from NB 0. Thus, in some specifications, the UEs transmit SYNC-UL at different times with respect to NB 0's timeline while the NBs 1-3 transmit at the same time. Accordingly, the transmitted SYNC-UL's of the UEs 1-4 arrive at NB 0 with round trip delay and the transmitted signals from NBs 1-3 arrive at NB 0 with a one way delay.

Further, the timing advance associated with UE 1 may correspond to the timing advance of the base timeline of NB 0 that that may correspond to a guard period of 48 chips. Because multiple user equipments and node Bs access NB 0 the guard periods for each of those devices may be subject to interference caused by uplink and downlink transmission associated with the other user equipments and node Bs.

FIG. 6 is a block diagram 600 illustrating the relative timing differences experienced by NB 0 of receiving (RX) uplink transmission from UEs 1 through 4 of SYNC-UL carried by UpPCH 1 through UpPCH 4 as well as receiving DwPTS by NBs 1-3. For example, SYNC-UL carried by UpPCH 1 from UE 1 and SYNC-UL carried by UpPCH 2 from UE 2 arrive at NB 0 at different times. Similarly, DwPTS transmitted by NB 1 are received by NB 0 at a different time than DwPTS transmitted by NB 3. Also illustrated in FIG. 6 is the relative power of communications between NB 0 and the other devices shown in FIG. 5. As illustrated in FIG. 6, the relative heights of the shown subframes illustrate (not to scale) the relative power of such communications, with communications with more distant devices (such as UE 4 or NB 3) having less power than communications with more proximate devices (such as UE 1 or NB 1). In some configurations, the power of the NBs 1-3 have no compensation. Thus, the received power at NB 0 associated with NBs 1-3 has a large difference depending on the distance of NB 1, NB 2 or NB 3 from NB 0. In contrast, the power of the UEs 1-4 is subject to path loss compensation. As a result, the difference in the received power of the UEs 1-4 is reduced are less likely to be dependent on the distance of the UEs 1-4 from NB 0.

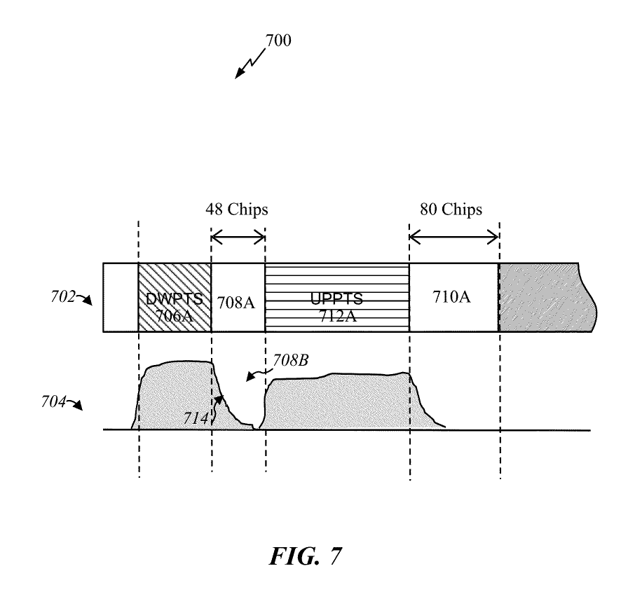

FIG. 7 is a block diagram 700 showing an exemplary base timeline of node B 702 and a subframe structure transmission timeline 704 illustrating interference observed by NB 0 according to an initial timing advance selection of 48 chips. Uplink and/or downlink transmission scheduled in accordance with subframe structure transmission timeline 702 may experience interference due to the subframe structure transmission timeline 704, which may be communications between a node B and another device. A second guard period 708B of the subframe structure transmission timeline 704, which corresponds to a first guard period 708A between the DwPTS 706A and the UpPTS 712A is 48 chips corresponding to the initial timing advance of 48 chips. The third guard period 710A is 80 chips. As illustrated in FIG. 7, the second guard period 708B is subject to interference illustrated by the interference signal 714 extending into the second guard period 708B. The interference may be distributed within the second guard period 708B. The interference distributed in the second guard period 708B of the subframe structure transmission timeline 704 may be composed of interference caused by DwPTS and SYNC-UL of a variety of delay.

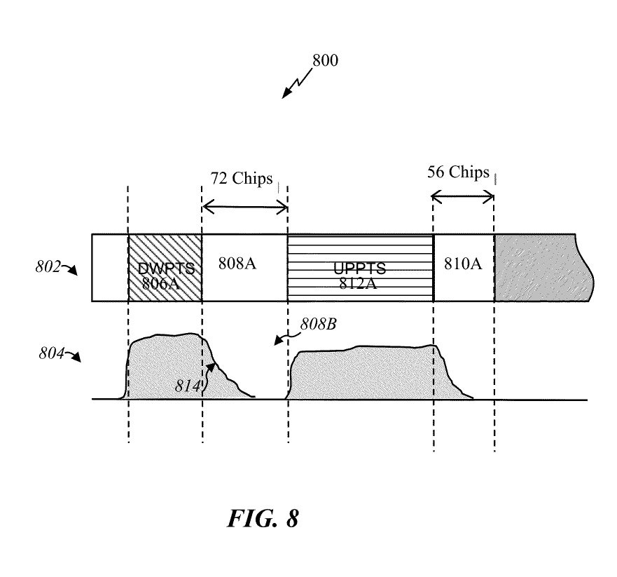

FIG. 8 is a block diagram showing an exemplary base timeline of node B and a subframe structure transmission timeline illustrating interference observed by NB 0 according to an initial timing advance selection of 24 chips. Similar to the illustration in FIG. 7, uplink and/or downlink transmission scheduled in accordance with subframe structure transmission timeline 804 may be subject to interference. A second guard period 808B of the subframe structure transmission timeline 804, which corresponds to a first guard period 808A between the DwPTS 806A and the UpPTS 812A is 72 chips corresponding to the initial timing advance of 24 chips. The third guard period 810A is 56 chips. As illustrated in FIG. 8, the second guard period 808B is subject to interference illustrated by the signal 814 extending into the second guard period 808B. As shown in FIGS. 7 and 8, the timing advance and/or guard period values may be adjusted to reduce the interference experienced in a particular guard period.

Offered is a method and system for reducing the interference and improve the random access of the multiple users in the network. One aspect of the present disclosure analyzes interference distribution between the first guard period between the DwPTS and the UpPTS and selects a timing advance based on the interference distribution. Selecting a better initial timing advance may reduce interference in the guard period and improve the signal to noise ratio of the SYNC-UL, thereby improving UE performance.

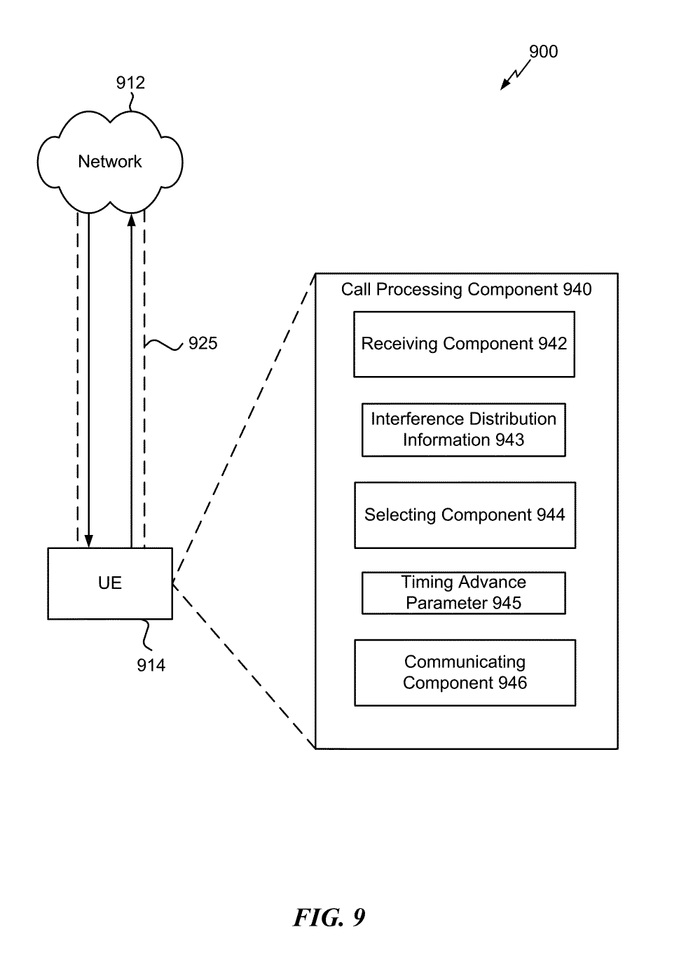

Referring to FIG. 9, in one aspect of the present apparatus and method, a wireless communication system 900 is configured to include wireless communications between network 912, which includes NB 0, and UE 914. The wireless communications system may be configured to support communications between a number of users. FIG. 9 illustrates a manner in which network 912 communicates with UE 914. The wireless communication system 900 can be configured for downlink message transmission or uplink message transmission over wireless link 925, as represented by the up/down arrows between network 912 and UE 914.

In an aspect, within the UE 914 resides a call processing component 940. The call processing component 940 may be configured, among other things, to include a receiving component 942 capable of receiving a interference distribution information. For example, receiving component 942, residing in the call processing component 940 of UE 914, is configured for receiving the interference distribution information 943 from network 912 over wireless link 925.

In another aspect, the call processing component 940 may be configured to include a selecting component 944 configured for selecting a timing advance parameter for uplink synchronization based at least in part on the interference distribution information. For example, selecting component 944 is configured for selecting the timing advance parameter 945 for uplink synchronization based at least in part on the interference distribution information 943.

In another aspect, the call processing component 940 may be configured to include a communicating component 946 configured for communicating according to the selected timing advance parameter. For example, communicating component 946 is configured to allow UE 914 to communicate with network 912 according to the selected timing advance parameter 945.

In an aspect, for example, UE 114 of wireless communication system 900 may be executed by UE 350 (FIG. 3) and may include the memory 392, and/or the controller/processor 390, or respective components thereof.

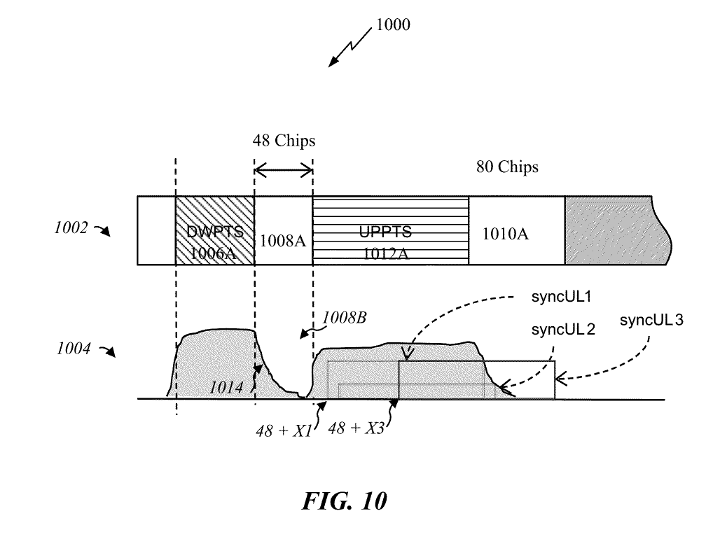

FIG. 10 is a block diagram 1000 showing an exemplary base timeline 1002 of a node B and a subframe structure transmission timeline 1004 illustrating a selection of one or more initial timing advance to mitigate interference. Similar to the implementation of FIG. 7, the implementation of FIG. 10 is based on an initial timing advance of 48 chips. In this aspect, one or more timing advances may be selected to reduce the interference. The interference may be illustrated by the interference signal 1014 extending into the second guard period 1008B based on the initial timing advance of 48 chips. In this aspect, to mitigate the interference associated with the second guard period 1008B, a different initial timing advance may be selected to adjust the position of the SYNC-UL on the subframe structure transmission timeline 1004. In one aspect, the timing advance may be selected to increase the second guard period 1008B relative to the first guard period 1008A of the base timeline of node B 1002, which corresponds to the initial timing advance of 48 chips. For example, the second guard period 1008B may be increased from 48 chips to 48+X1 chips along with reducing the initial timing advance by a factor of X1. Reducing the timing advance by X1 chips advances the SYNC-UL 1 on the subframe structure transmission timeline 1004 to accommodate the interference in the second guard period 1008B rather than in the first guard period 1008A. Similarly, reducing the timing advance by X2 chips or by X3 chips advances the SYNC-UL 2 or SYNC-UL 3 on the subframe structure transmission timeline 1004 to 48+X2 chips and 48+X3 chips respectively. Because the size of the second guard period 1008B is an adjustment from the standard 96 chip guard period, the timing advance may be selected to extend the second guard period 1008B up to 96+32 chips for a total of 128 chips, owing to the guard period of 32 chips after UpPTS.

In this aspect, transmitting based on the reduced timing advance associated with SYNC-UL 3 may be more desirable than transmitting based on the timing advance associated with SYNC-UL 2 and SYNC-UL 1 because of a reduced signal to noise ratio associated with SYNC-UL 3 in the first guard period 1008A. An example illustration of the signal to noise power analysis is as follows:
Suppose a busy traffic environment, and initial timing advance=48 chips with no UpPCH shift.
SNR1=Ps1/Pi1; where SNR1 is the signal to noise ratio of transmitting according to the reduced timing advance of 48−X1 chips, Ps1 is the SYNC-UL 1 receive power and Pi1 is the interference power.
SNR2=Ps2/Pi2; where SNR2 is the signal to noise ratio of transmitting according to the reduced timing advance of 48−X2 chips, Ps2 is the SYNC-UL 2 receive power and Pi2 is the interference power.
SNR3=Ps3/Pi3; where SNR3 is the signal to noise ratio of transmitting according to the reduced timing advance of 48−X3 chips, Ps3 is the SYNC-UL 3 receive power and Pi3 is the interference power.
Assuming Pi3<Pi2<Pi1; then Ps3=Ps1=Ps2 (due to UEs path loss compensation algorithm); As a result, SNR3>SNR1>SNR2;

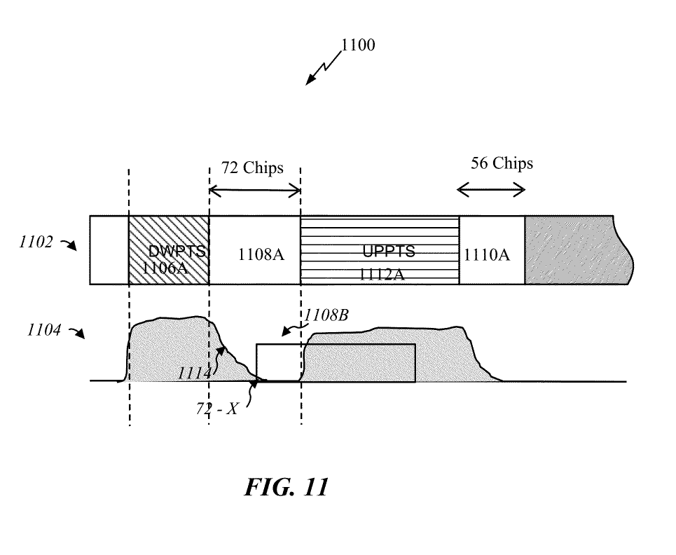

FIG. 11 is a block diagram 1100 an exemplary base timeline 1102 of a node B juxtaposed against a subframe structure transmission timeline 1104. Similar to the implementation of FIG. 8, the implementation of FIG. 11 is based on an initial timing advance of 24 chips. In this aspect, to mitigate the interference associated with the second guard period 1108B, increased timing advance may be selected to adjust the position of the SYNC-UL on the subframe structure transmission timeline 1104. In one aspect, the timing advance may be selected to decrease the second guard period 1108B relative to the first guard period 1108A of the base timeline of node B 1102, which corresponds to the initial timing advance of 24 chips. For example, the second guard period 1108B may be decreased from 48 chips to 72−X chips by increasing the initial timing advance by a factor of X. Other timing advance selections greater than 48 chips may be appropriate to accommodate the interference condition.

In one aspect, the timing advance is selected based on the interference distribution. Thus, the interference distribution between the 96 chips guard period between the DwPTS and the UpPTS may be analyzed. Based on the interference distribution a timing advance may be selected to accommodate the interference. In one aspect, the interference distribution may be analyzed independent of the UE. In this aspect, the UE may be configured to receive the interference distribution information based on the interference distribution analysis. A timing advance may be selected based on the received interference distribution information.

In one aspect, a node B measures the interference between the 96 chips guard period and broadcast the interference information to the UE. The UE may select the timing advance based on the broadcasted interference information to reduce interference for transmitting SYNC-UL.

In another aspect, a UE may also listen for potential interference during an otherwise inactive period. The UE may take the identified interference during this period and then base a timing advance on this interference distribution.

In one aspect, the guard period of 48+16 chips is divided into N discrete sections with each section including 64/N chips. One or more of the discrete sections may be selected as the initial timing advance and the random access success/failure rate may be monitored based on the selection of each of the one or more timing advances. For example, in defining randomization, suppose there are two sections, such as 48 chips and 24 chips, where the success rate of 48 chips is 1 and that of 24 chips is 0.1. If after selecting the initial timing advance of 48 chips fails, the success rate is updated by a filter (e.g. by a filter coefficient of 0.1). Thereafter, the success rate of selecting a timing advance of 48 chips will become 0.9. Indeed, even if the success rate of selecting 48 chips (=0.9) is higher than that of selecting 24 chips (=0.1), the next timing advance chosen will be 24. As such, all the possible timing advances are chosen based on the success rate before the timing advance already selected is chosen. Other forms of randomization may include coin-tossing or sequential try.

A timing advance associated with the one or more discrete sections may also be selected based on the result of the monitoring. For example, the timing advance of the discrete section with a better success rate may be selected for transmitting SYNC-UL.

In one aspect, the interference distribution in the 96 chips guard period may be measured during operation or field testing of the UE. The measurement results may be implemented into a predefined timing advance selection table including one or more timing advances. The random access success rate of each timing advance may be indicated in the predefined timing advance selection table. The timing advance may be selected from the predefined timing advance selection table for future use. In one aspect of the disclosure, the interference may be measured when the UE is in the idle mode. An average interference distribution may be generated after measuring over a period of time. In a random access communication, a UE may select sequentially or randomly select one or more timing advances on the predefined timing advance selection table until the SyncUL procedure succeeds. It should be noted that both pre-defined timing advance selection table are dynamically updated and saved during the above operation.

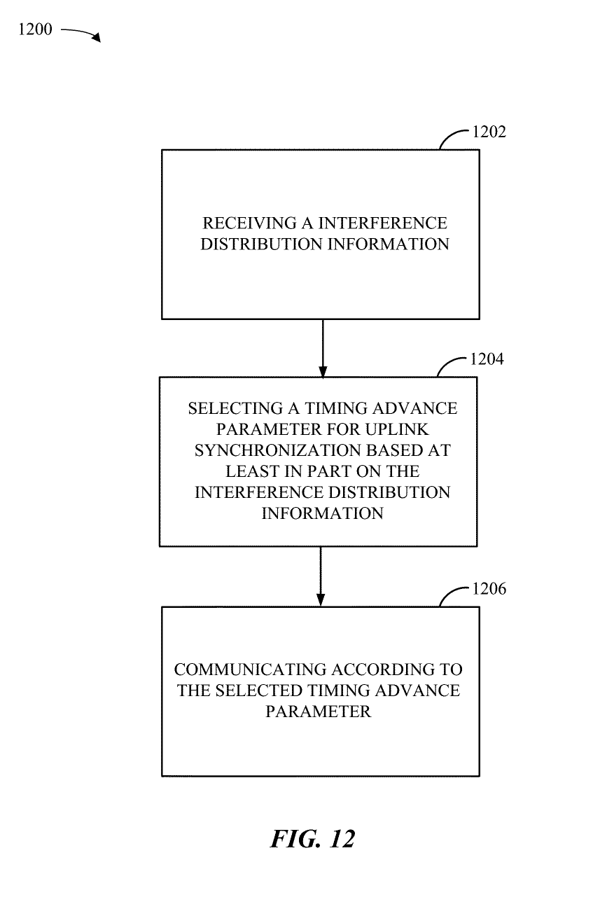

FIG. 12 shows a wireless communication method 1200 according to one aspect of the disclosure. At 1202, method 1200 includes receiving an interference distribution information. For example, as discussed above with reference to FIG. 9, receiving component 942 of UE 914 is configured for receiving the interference distribution information 943 from network 912 over wireless link 925.

At 1204, selecting a timing advance parameter for uplink synchronization based at least in part on the interference distribution information occurs. For example, after receiving the interference distribution information 943 from network 912, selecting component 944 of UE 914 is configured for selecting the timing advance parameter 945 for uplink synchronization to network 912 based at least in part on the interference distribution information 943.

At 1206, communicating according to the selected timing advance parameter occurs. For example, after selecting the timing advance parameter 945 for uplink synchronization to network 912, communicating component 946 is configured to allow UE 914 to communicate with network 912 according to the selected timing advance parameter 945.

In an aspect, for example, UE 114 of executing method 1200 may be executed by UE by UE 350 (FIG. 3) and may include the memory 392, and/or the controller/processor 390, or respective components thereof.

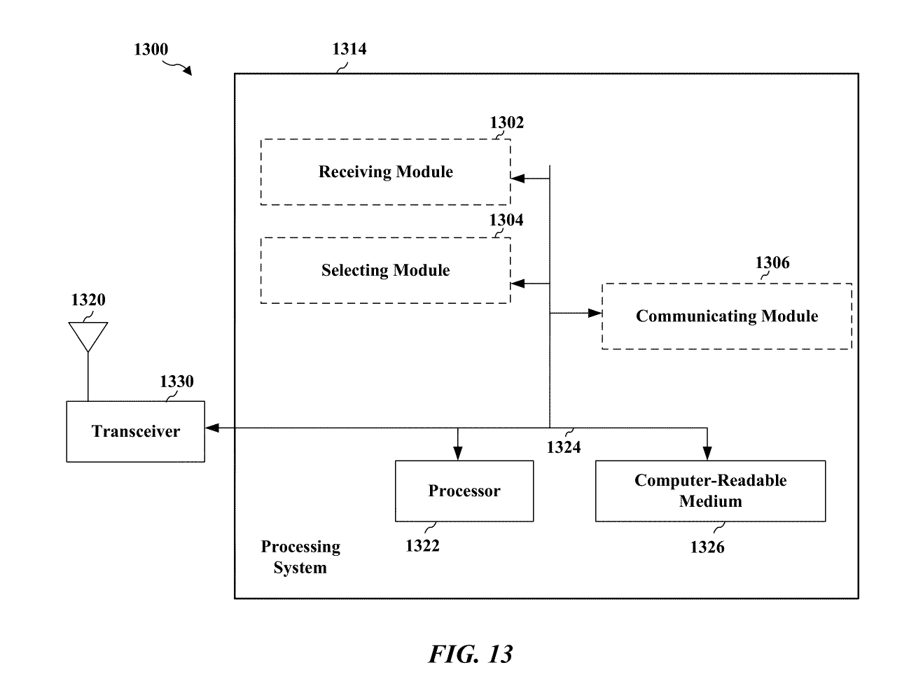

FIG. 13 is a diagram illustrating an example of a hardware implementation for an apparatus 1300 employing a timing advance selection system 1314. The timing advance selection system 1314 may be implemented with a bus architecture, represented generally by the bus 1324. The bus 1324 may include any number of interconnecting buses and bridges depending on the specific application of the timing advance selection system 1314 and the overall design constraints. The bus 1324 links together various circuits including one or more processors and/or hardware modules, represented by the processor 1322, the receiving module 1302, the selecting module 1304, the communicating module 1304 and the computer-readable medium 1326. The bus 1324 may also link various other circuits such as timing sources, peripherals, voltage regulators, and power management circuits, which are well known in the art, and therefore, will not be described any further.

The apparatus includes a timing advance selection system 1314 coupled to a transceiver 1330. The transceiver 1330 is coupled to one or more antennas 1320. The transceiver 1330 enables communicating with various other apparatus over a transmission medium. The timing advance selection system 1314 includes a processor 1322 coupled to a computer-readable medium 1326. The processor 1322 is responsible for general processing, including the execution of software stored on the computer-readable medium 1326. The software, when executed by the processor 1322, causes the timing advance selection system 1314 to perform the various functions described for any particular apparatus. The computer-readable medium 1326 may also be used for storing data that is manipulated by the processor 1322 when executing software.

The timing advance selection system 1314 includes the selecting module 1302 for selecting a timing advance parameter for uplink synchronization based at least in part on an interference distribution information in a guard period of a frame in a TD-SCDMA network. The timing advance selection system 1314 includes the communicating module 1304 for communicating according to the selected timing advance parameter. The modules may be software modules running in the processor 1322, resident/stored in the computer-readable medium 1326, one or more hardware modules coupled to the processor 1322, or some combination thereof. The timing advance selection system 1314 may be a component of the UE 350 and may include the memory 392, and/or the controller/processor 390.

In one configuration, an apparatus such as a UE is configured for wireless communication including means for selecting. In one aspect, the above means may be the controller/processor 390, the memory 392, the receive frame processor 360, the transmit frame processor 382, the receive processor 370, the transmit processor 380, the timing advance selection module 391, selecting module 1302, and/or the timing advance selection system 1314 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for selecting. In one aspect, the above means may be the controller/processor 390, the memory 392, the timing advance selection module 391, selecting module 1304, and/or the timing advance selection system 1314 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving an interference distribution information;
selecting a timing advance parameter for uplink synchronization based at least in part on the interference distribution information; and
communicating according to the selected timing advance parameter.

2. The method of claim 1, wherein the interference distribution information is based at least in part on an interference within a guard period of a frame caused by uplink and downlink transmission from one or more UEs and/or one or more node Bs in a network.

3. The method of claim 2, further comprising dividing the guard period into N discrete sections with each section including 64N chips.

4. The method of claim 3, further comprising:
selecting the timing advance parameter based on at least one of the N discrete sections; and
determining a random access communication success rate associated with each of the at least one of the N discrete sections.

5. The method of claim 4, further comprising selecting the timing advance parameter based on the random access communication success rate.

6. The method of claim 4, further comprising calculating a predefined timing advance parameter selection table for implementing a future timing advance selection.

7. The method of claim 6, wherein the predefined timing advance parameter selection table indicates the random access communication success rate for each timing advance.

8. The method of claim 6, further comprising sequentially selecting one or more timing advances on the predefined timing advance parameter selection table until an identification of an appropriate timing advance for communication.

9. The method of claim 6, further comprising randomly selecting one or more timing advances on the predefined timing advance parameter selection table until an identification of an appropriate timing advance for communication.

10. The method of claim 6, wherein timing advance parameter selection table is dynamically updated and saved.

11. The method of claim 1, further comprising determining the interference distribution information by measuring interference at a UE when the UE is in an idle mode.

12. An apparatus of wireless communication, comprising:
at least one processor; and
receive an interference distribution information;
select a timing advance parameter for uplink synchronization based at least in part on the interference distribution information; and
communicate according to the selected timing advance parameter.

13. The apparatus of claim 12, wherein the interference distribution information is based at least in part on an interference within a guard period of a frame caused by uplink and downlink transmission from one or more UEs and/or one or more node Bs in a network.

14. The apparatus of claim 13, wherein the at least one processor is further configured to divide the guard period into N discrete sections with each section including 64N chips.

15. The apparatus of claim 14, wherein the at least one processor is further configured to:
select the timing advance parameter based on at least one of the N discrete sections; and
determine a random access communication success rate associated with each of the at least one of the N discrete sections.

16. The apparatus of claim 15, wherein the at least one processor is further configured to select the timing advance parameter based on the random access communication success rate.

17. The apparatus of claim 15, wherein the at least one processor is further configured to calculate a predefined timing advance parameter selection table for implementing a future timing advance selection.

18. The apparatus of claim 17, wherein the predefined timing advance parameter selection table indicates the random access communication success rate for each timing advance.

19. The apparatus of claim 17, wherein the at least one processor is further configured to sequentially select one or more timing advances on the predefined timing advance parameter selection table until an identification of an appropriate timing advance for communication.

20. The apparatus of claim 17, wherein the at least one processor is further configured to randomly select one or more timing advances on the predefined timing advance parameter selection table until an identification of an appropriate timing advance for communication.

21. The apparatus of claim 17, wherein timing advance parameter selection table is dynamically updated and saved.

22. The apparatus of claim 12, wherein the at least one processor is further configured to determine the interference distribution information by measuring interference at a UE when the UE is in an idle mode.

23. A apparatus of wireless communication, comprising:
means for receiving an interference distribution information;
means for selecting a timing advance parameter for uplink synchronization based at least in part on the interference distribution information; and
means for communicating according to the selected timing advance parameter.

24. A computer program product stored on a computer readable medium, comprising code for:
receiving an interference distribution information;
selecting a timing advance parameter for uplink synchronization based at least in part on the interference distribution information; and
communicating according to the selected timing advance parameter.
